(19) United States
(12) Patent Application Publication
(10) Pub. No.: US 2011/0154960 A1
(43) Pub. Date: Jun. 30, 2011

(54) TOOL ASSEMBLY HAVING MULTIPLE BITS

(76) Inventor: CHIN-FU SUNG, Ta-Li City (TW)

(21) Appl. No.: 12/648,046

(22) Filed: Dec. 28, 2009

(51) Int. Cl. B25B 15/02; B25G 1/08

(52) U.S. Cl. 81/440; 81/177.4

(57) ABSTRACT

A tool assembly includes a front part and a second part. The first part includes a handle and a shank extending from an end of the handle. A polygonal recess is defined in an end of the shank. The rear part includes a rotation unit, a holding unit and a driving unit. The rotation unit is rotatably connected to the holding unit which includes an outer case and an inner case. The outer case includes receiving holes in an end thereof and the receiving holes communicate with storage spaces defined between the inner and outer cases. The driving unit extends through the inner case and the rotation unit. The front part is removably mounted to the shank that extends out from the rotation unit. The rotation unit includes a notch which is moved to be aligned with one of the receiving holes to pick tool out from the storage space.

### FIELD OF THE INVENTION

The present invention relates to a tool assembly, and more particularly, to a tool assembly having multiple bits which can be received in the handle portion and picked by rotating the operation unit.

### BACKGROUND OF THE INVENTION

A conventional tool assembly generally includes a base and a cover wherein the base includes an engaging portion in a front end thereof and a recess is defined in a rear end of the base. The base includes multiple reception spaces so as to receive bits or sleeves or the like. The cover includes a connection portion at a front end thereof and a protrusion extending from a rear end of the cover. The protrusion is engaged with the recess of the base so as to be rotated. The engaging portion of the base and the connection portion of the cover are connected to each other to assemble the tool assembly.

However, there are several drawbacks found during use:

1. The tool assembly cannot be carried conveniently so that the user has to remove the bits or sleeves or the like from the reception spaces and put required bits or sleeves or the like. In other words, the user has to change different shapes and sizes of the bits or the sleeves or the like back and forth during use.

2. When using the tool assembly, the bits or the sleeves or the like are removed from the base and then the required bit or sleeve or the like is chosen and engaged with the recess so as to tighten or loosen the objects. Therefore, extra space is needed to store the bits or the sleeves or the like, and the space sometimes is not available.

The present invention intends to provide a tool assembly which includes multiple bits or sleeves or the like received in the rear part of the tool assembly and the individual bit or sleeve or the like can be picked and used conveniently.

### SUMMARY OF THE INVENTION

The present invention relates to a tool assembly and comprises a front part having a handle and a shank which extends from a first end of the handle and has a polygonal recess defined in a first end thereof. A driving end is formed on a second end of the shank and located in a reception area defined in a second end of the handle. A rear part includes a rotation unit, a holding unit and a driving unit, wherein the rotation unit includes a main portion which includes an axial hole defined therethrough and an operation portion is connected to an outside of the main portion and includes a notch. The rotation unit is rotatable relative to the holding unit. The holding unit includes a passage defined centrally therethrough and a plurality of storage spaces are defined in an outside of the holding unit. The rotation unit and the driving unit are received in the passage and tools can be received in the storage spaces. The driving unit includes an engaging portion in a first end thereof and a securing portion is formed at a second end of the driving unit. The securing portion secures the driving unit to the passage of the holding unit. The front part is removably mounted to the first end of the driving unit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the tool assembly of the present invention;

FIG. 2 is a cross sectional view to show the parts of the rear part of the tool assembly of the present invention;

FIG. 3 is a cross sectional view to show that tools are received in the rear part of the tool assembly of the present invention;

FIG. 4 is a cross sectional view to show that one of the tools can be picked out from the rear part of the tool assembly of the present invention when rotating the notch of the rotation unit to a position;

FIG. 5 is a cross sectional view to show that the front part is mounted to the first end of the driving unit of rear part of the tool assembly of the present invention, and

FIG. 6 is a cross sectional view to show another embodiment of the parts of the rear part of the tool assembly of the present invention.

### DETAILED DESCRIPTION OF THE PREFERRED EMBODIMENT

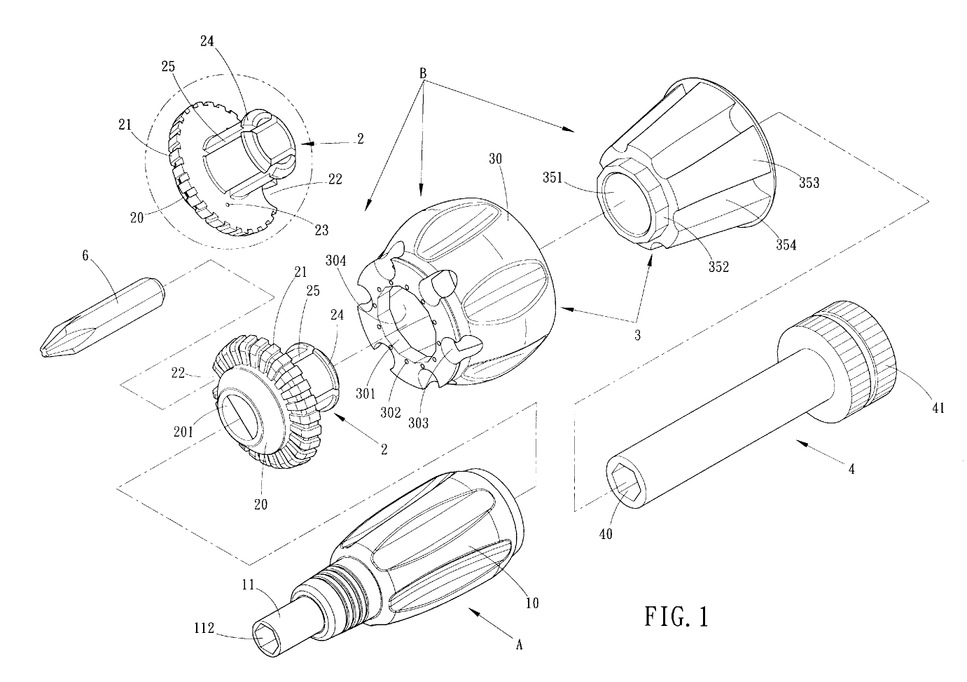

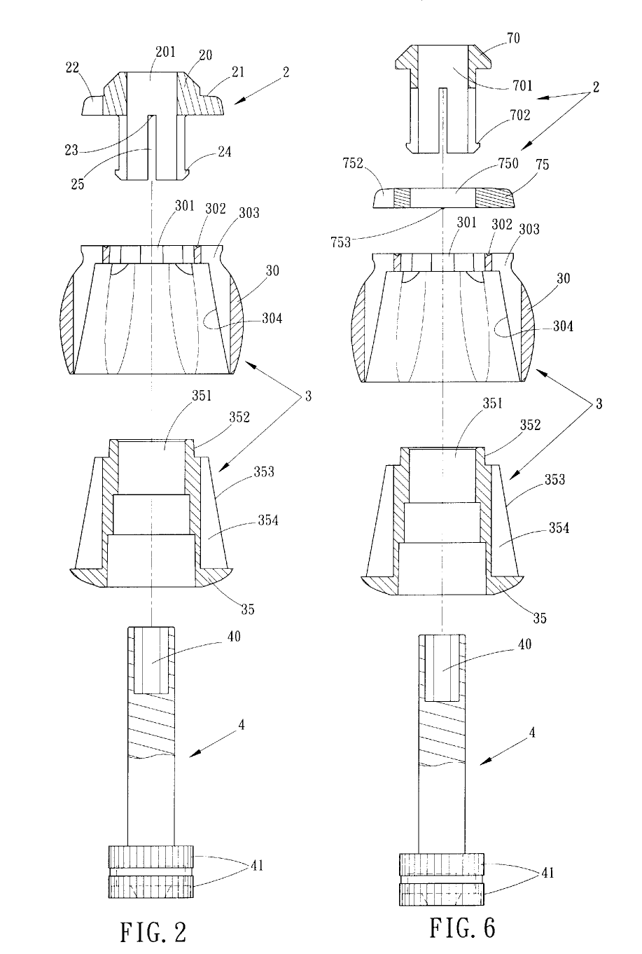

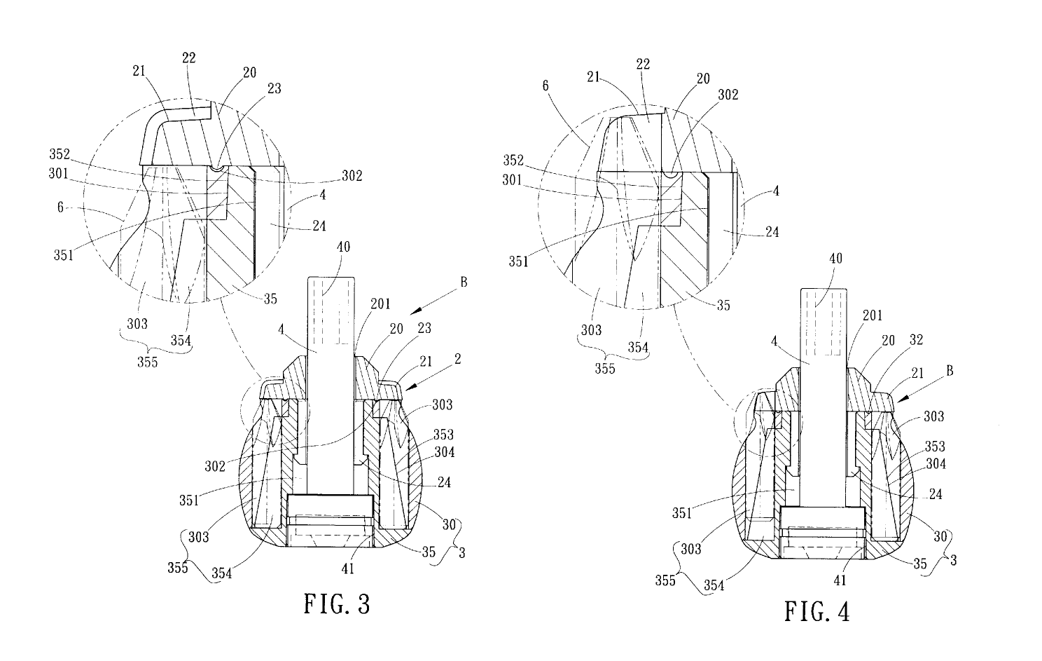

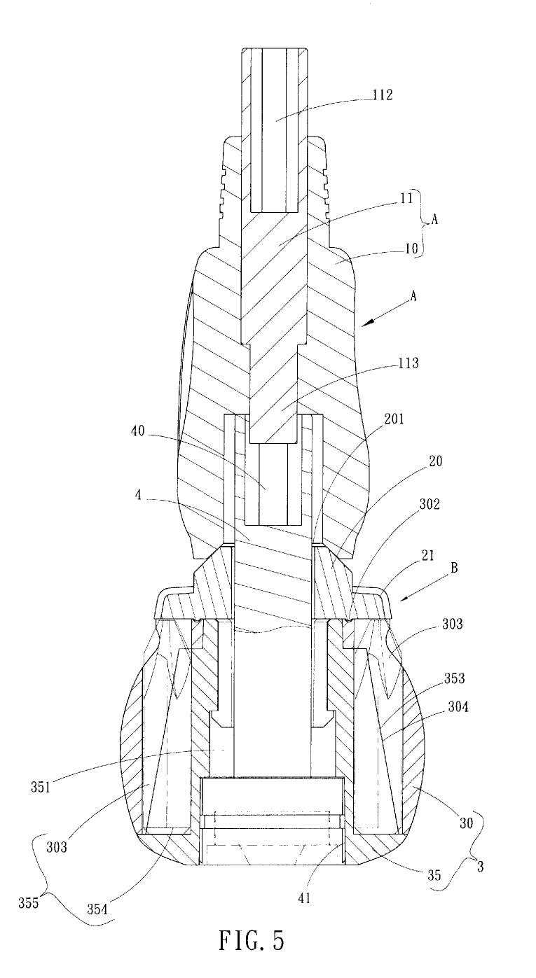

Referring to FIGS. 1, 2, 3 and 5, the tool assembly of the present invention comprises a front part “A” and a rear part “B”. The front part “A” includes a handle 10 and a shank 11 which extends from a first end of the handle 10 and has a polygonal recess 112 defined in a first end thereof so as to be connected with a bit 6. A driving end 112 is formed on a second end of the shank 11 and located in a reception area 101 defined in a second end of the handle 10.

The rear part “B” includes a rotation unit 2, a holding unit 3 and a driving unit 4. The rotation unit 2 includes a main portion 20 which includes an axial hole 201 defined therethrough and an operation portion 21 is connected to an outside of the main portion 20. The operation portion 21 includes a notch 22 defined in an outer periphery thereof. A connection mechanism is formed between a joint of the rotation unit 2 and the holding unit 3 such that the rotation unit 2 is rotatable relative to the holding unit 3. The connection mechanism includes multiple elongate plates extending from an end of the rotation unit 2 and slots 25 are defined between the elongate plates so that the elongate plates are flexible. Each elongate plate includes a hook 24 extending outward therefrom. Two first positioning portions 23 are formed on an end surface the rotation unit 2.

The holding unit 3 includes an outer case 30 and an inner case 35 which is located within the outer case 30. The outer case 30 includes a central hole 301 defined therethrough and a plurality of second positioning portions 302 are defined in an end surface of a first end of the outer case 30. The second positioning portions 302 are located around an opening defined by the central hole 301 in the end surface. A plurality of receiving holes 303 are defined in the first end of the outer case 30. The outer case 30 includes a cone-shaped space 304 defined in a second end thereof and the cone-shaped space 304 communicates with the central hole 301 and the receiving hole 303. The inner case 35 is located in the cone-shaped space 304 and includes a passage 351. The elongate plates of the rotation unit 2 extend into the passage 351 and the hooks 24 are engaged with a stepped inner periphery of the passage 351 of the holding unit 3. When rotating the rotation unit 2, the first positioning portions 23 are engaged with the second positioning portions 302 so that the user knows the angular position that the rotation unit 2 is rotated. A neck portion 352 extends from a first end of the inner case 35 and is shaped to be engaged with the central hole 301 of the outer case 30. The inner case 35 includes a cone-shaped body 353 which has multiple grooves 354 defined in an outer surface thereof. When the cone-shaped body 353 is received in the cone-shaped space 304, the receiving holes 303 of the outer case 30 and the recesses 354 of the inner case 35 define storage spaces 355 such that the tools 6 are received in the storage spaces 355.

The driving unit 4 has an engaging portion 40 in a first end thereof and a securing portion 41 is formed at a second end of the driving unit 4. The securing portion 41 includes metal teeth which securely engaged with plastic made passage 351 so as to connect the driving unit 4 to the holding unit 3.

Further referring to FIG. 4, when using the rear part “B”, the user may rotate the operation portion 21 until the notch 22 is in alignment with one of the receiving holes 303 so that the tool 6 in that the storage space 355 can be picked out via the receiving holes 303 and the notch 22. The tool 6 is then engaged with the engaging portion 40 of the driving unit 4. The rest of the receiving holes 303 are covered by the operation portion 21. It is noted that the front part “A” can also be used individually by connecting a tool 6 with the polygonal recess 112.

When the object to be tightened or loosened is located in a deep hole, the front part “A” is mounted to the first end of the driving unit 4 and the tool 6 can be engaged with the polygonal recess 112 of the front part “A”. By this way, the tool 6 can reach a deep position.

Referring to FIG. 6, the rotation unit 2 of the rear part “B” can be composed of a main portion 70 and an operation portion 75, both of which are two individual parts. The main portion 70 includes the axial hole 701 and the hooks 702 extend outward from the rotation unit 2. The hooks 702 extend through a through hole 750 of the operation portion 75 and are engaged with a first stepped inner periphery of the passage 351 of the holding unit 3. The operation portion 75 includes the notch 752 and the first positioning portion 753 is formed on the surface thereof.

While we have shown and described the embodiment in accordance with the present invention, it should be clear to those skilled in the art that further embodiments may be made without departing from the scope of the present invention.

What is claimed is:

1. A tool assembly comprising:
a front part having a handle and a shank, the shank extending from a first end of the handle and having a polygonal recess defined in a first end thereof, a driving end formed on a second end of the shank and located in a reception area defined in a second end of the handle;
a rear part having a rotation unit, a holding unit and a driving unit, the rotation unit having a main portion which includes an axial hole defined therethrough, an operation portion connected to an outside of the main portion and including a notch defined in an outer periphery thereof, a connection mechanism formed between a joint of the rotation unit and the holding unit such that the rotation unit is rotatable relative to the holding unit;
the holding unit having a passage defined centrally therethrough and a plurality of storage spaces defined in an outside of the holding unit, the rotation unit and the driving unit being received in the passage and tools received in the storage spaces, and
the driving unit having an engaging portion in a first end thereof and a securing portion formed at a second end of the driving unit, the securing portion securing the driving unit to the passage of the holding unit, the front part being removably mounted to the first end of the driving unit.

2. The assembly as claimed in claim 1, wherein the connection mechanism includes hooks formed on the rotation unit and the hooks are engaged with a stepped inner periphery of the passage of the holding unit.

3. The assembly as claimed in claim 2, wherein a first positioning portion is formed on an end surface the rotation unit and multiple second positioning portions are formed on an end surface of the holding unit, the first positioning portion is engaged with one of the multiple second positioning portions.

4. The assembly as claimed in claim 3, wherein the main portion and the operation portion of the rotation unit are two individual parts, the main portion includes the axial hole and the hooks extend outward from the rotation unit, the hooks extend through a through hole of the operation portion and are engaged with a first stepped inner periphery of the passage of the holding unit, the operation portion includes the notch and the first positioning portion is formed on the surface thereof.

5. The assembly as claimed in claim 3, wherein the holding unit includes an outer case and an inner case, the outer case includes a central hole defined therethrough and a plurality of second positioning portions are defined in an end surface of a first end of the outer case, the second positioning portions are located around an opening defined by the central hole in the end surface, a plurality of receiving holes are defined in the first end of the outer case, the outer case includes a cone-shaped space defined in a second end thereof, the cone-shaped space communicates with the central hole and the receiving hole, the inner case is located in the cone-shaped space and includes the passage, a neck portion extends from a first end of the inner case and is shaped to be engaged with the central hole of the outer case, the inner case includes a cone-shaped body which has multiple grooves defined in an outer surface thereof, when the cone-shaped body is received in the cone-shaped space, the receiving holes of the outer case and the recesses of the inner case define storage spaces.

6. The assembly as claimed in claim 3, wherein the first positioning portion is a boss and the multiple second positioning portions are recesses.
